(19) United States
(12) Patent Application Publication
(10) Pub. No.: US 2014/0173121 A1
(43) Pub. Date: Jun. 19, 2014

(54) METHOD, DEVICE AND COMPUTER-READABLE STORAGE MEDIUM FOR CLIENT INTERACTION OF A NETWORK APPLICATION EXECUTED BY COMPUTER

(71) Applicant: Tencent Technology (Shenzhen) Company Limited, Shenzhen (CN)

(72) Inventor: Yingzhao Qiu, Shenzhen (CN)

(73) Assignee: TENCENT TECHNOLOGY (SHENZHEN) COMPANY LIMITED, Shenzhen (CN)

(21) Appl. No.: 14/186,407

(22) Filed: Feb. 21, 2014

Related U.S. Application Data
(63) Continuation of application No. PCT/CN2013/071375, filed on Feb. 5, 2013.

(30) Foreign Application Priority Data
Feb. 20, 2012 (CN) 201210038374.3

(51) Int. Cl. H04L 29/06

(52) U.S. Cl. CPC H04L 65/1069
USPC 709/227

(57) ABSTRACT

A method for client interaction of a network application executed by computer including: acquiring an interactive instruction of the network application in the session window, transferring the interactive instruction to a connected client in the session by a client interface of the session window, and updating the web application page in the client following the interactive instruction, to get an updated network application web page. The client is a client that generates the session window.

### CROSS REFERENCE TO RELATED APPLICATION

This application is a continuation application of an International Application No. PCT/CN2013/071375, filed Feb. 5, 2013, entitled “METHOD, DEVICE AND COMPUTER-READABLE STORAGE MEDIUM FOR CLIENT INTERACTION OF A NETWORK APPLICATION EXECUTED BY COMPUTER,” by Yingzhao QIU, which claims the priority from the Chinese patent application No. CN201210038374.3, filed Feb. 20, 2012, entitled “METHOD, AND DEVICE FOR INTERACTION OF A NETWORK APPLICATION” by Yingzhao QIU, all of which are hereby incorporated herein by reference.

### FIELD OF THE INVENTION

The present disclosure relates generally to Internet technology, and more particularly, to a method, device and computer-readable storage medium for client interaction of a network application executed by computer.

### BACKGROUND OF THE INVENTION

With the rapid development of Internet application, the open platform has been a new trend of the development of the Internet, which needs to support different application scenarios. Existing open platforms are embedded in the browser in webpage format, and the browser simply provides a window for web hosting and only involves communication between the webpage and the web server. For example, the web page provides links for various network applications, by use of any link the current page can be jumped to a page that the corresponding network application is on, and the network application can communicate with the web server by the page that the network application is on.

However, the interaction between users can not be achieved in existing open platforms, so in addition to an open platform server configured to load the open platform web page, the back-end is also provided with an application module configured to call the open platform server, in order to achieve interactive communication between different users of the same network application in the open platform. In the frond-end open platform web page, the network application queries friend relationship information in the open platform server by the application module, and the interactive communication between the user and his friends can be achieved based on the queried friend relationship information.

However, the interaction process of the network application in the open platform depends on the friend relationship information provided by the open platform server, the application module can acquire users' friend relationship information freely, and there is a risk of leaking the friend relationship information between the users and users' friends, resulting in low security.

### SUMMARY OF THE INVENTION

In view of the above, a principal object of the present disclosure is to provide a method for client interaction of a network application executed by computer, which can achieve the interaction between users with high security.

It is a further object of the present disclosure to provide an interactive device corresponding to the above interactive method and configured to execute the above interactive method.

It is still a further object of the present disclosure to a computer-readable storage medium storing computer executable instructions.

According to one aspect of the disclosure, a method for client interaction of a network application executed by computer includes the following steps:
acquiring an interactive instruction of the network application in the session window;
transferring the interactive instruction to a connected client in the session by a client interface of the session window; and
updating the web application page in the client following the interactive instruction, to get an updated network application web page,
wherein the client is a client that generates the session window.

According to an additional aspect of the disclosure, a client interaction device for network application includes:
an interaction acquisition module, configured to acquire interactive instruction of the network application in the session window;
a processing module, configured to transfer the interactive instruction to a connected client in the session by a client interface of the session window; and
an update module, configured to update the web application page in the client following the interactive instruction, to get an updated network application web page,
wherein the client is a client that generates the session window.

According to a further aspect of the disclosure, a computer-readable storage medium for storing computer executable instruction, the computer executable instruction is used to control a computer to execute the method for client interaction of a network application, wherein the method includes the following steps:
acquiring an interactive instruction of the network application in the session window;
transferring the interactive instruction to a connected client in the session by a client interface of the session window; and
updating the web application page in the client following the interactive instruction, to get an updated network application web page,
wherein the client is a client that generates the session window.

The above method and device for client interaction of a network application executed by computer firstly acquire interactive instruction of the network application in the session window, then the interaction between users in the network application is achieved by transferring the interactive instruction to a connected client in the session by a client interface of the session window and does not depend on the friend relationship information between the users and users' friends, so as to effectively protect the friend relationship information between the users and users' friends and improve the security.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flowchart illustrating a method for client interaction of a network application executed by computer according to one embodiment of the present disclosure.

FIG. 2 is a schematic diagram illustrating an open platform embedded in a session window according to one embodiment of the present disclosure.

FIG. 3 is a flowchart illustrating a method for client interaction of a network application executed by computer according to another embodiment of the present disclosure.

FIG. 4 is a schematic diagram illustrating an interaction request in a session window according to one embodiment of the present disclosure.

FIG. 5 is a flowchart illustrating a method for establishing a connection between clients where the user identifications are, according to the embodiment as shown in FIG. 3.

FIG. 6 is a flowchart illustrating a method for transferring the interactive instruction to a connected client in the session by a client interface of the session window, according to the embodiment as shown in FIG. 1.

FIG. 7 is a flowchart illustrating a method for updating the web application page in the client following the interactive instruction, according to the embodiment as shown in FIG. 1.

FIG. 8 is a structure diagram illustrating a client interaction device for network application according to one embodiment of the present disclosure.

FIG. 9 is a structure diagram illustrating a client interaction device for network application according to another embodiment of the present disclosure.

FIG. 10 is a structure diagram illustrating a connection module according to the embodiment as shown in FIG. 9.

FIG. 11 is a structure diagram illustrating a processing module according to the embodiment as shown in FIG. 8.

FIG. 12 is a structure diagram illustrating an update module according to the embodiment as shown in FIG. 8.

### DETAILED DESCRIPTION OF THE PREFERRED EMBODIMENTS

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

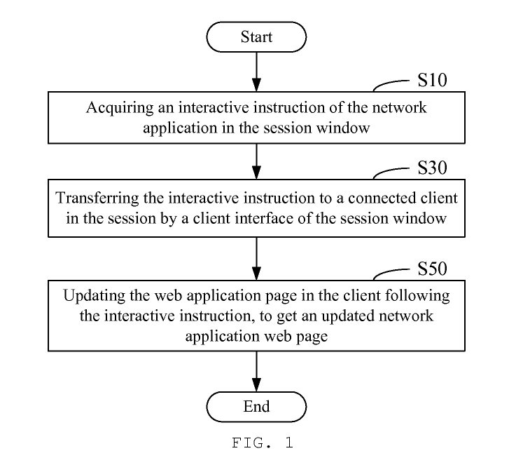

In one embodiment of the present disclosure, as shown in FIG. 1, a method for client interaction of a network application executed by computer includes the following steps.

Step 10, acquiring an interactive instruction of the network application in the session window.

In the embodiment, the session window is a window used when a user send a message to other users to talk by an instant online communication tool. As shown in FIG. 2, a web page of an open platform is embedded in the session window, which integrates a plurality of network applications and category navigations configured to quickly find needed network applications, and users can navigate to relevant network application pages by the category navigation on the web page. For example, when a user clicks a network application, the web page embedded in the session window will load a page corresponded by the clicked network application, to show the user an application scenario of the network application.

The user can interact with other users based on the network application by initiating an operation, such as application interaction, in the network application web page embedded in the session window. Meanwhile, an operation committed by a user in the network application web page can be transferred to a network application web page of another user at the far end by the interactive instruction which can be an instruction generated based on the operation, and the user at the far end can learn the operation happening in the interaction by the interactive instruction, and then reacts to it.

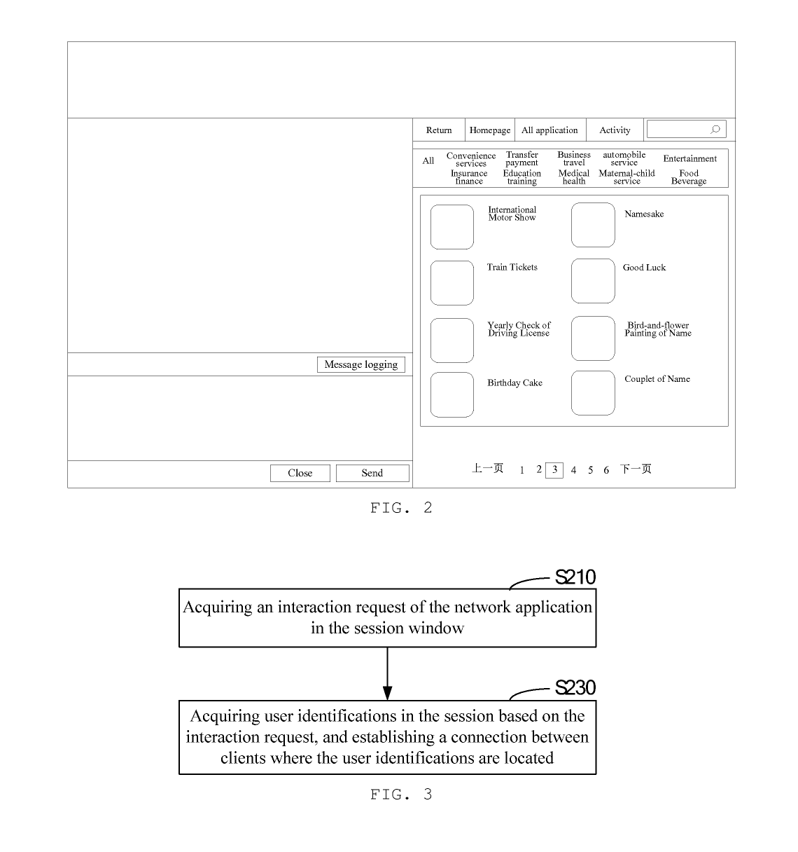

In another embodiment of the present disclosure, as shown in FIG. 3, before the Step S10, it further includes the following steps.

Step S210, acquiring an interaction request of the network application in the session window.

In the embodiment, before the interaction in the network application, it firstly needs to establish a communication channel between clients which is implemented by initiating an interaction request. The client can be an instant online communication tool, and a session window is generated by clicking a contact or friend in the client by a user. The interaction request is an interaction invitation message initiated by a user, as shown in FIG. 4, the interaction request 410 is shown in the session window, and the user who accepts the interaction request 410 can accept it or reject it.

Step S230, acquiring user identifications in the session based on the interaction request, and establishing a connection between clients where the user identifications are located.

In the embodiment, when a user logs into the client, the user identification is used to tag the user's identity. After logging into the client, the user identification in the session involves two users or more users in a group. For example, if a session is in a session window provided by the clients of two users, acquire user identifications corresponding to the two users; and if a session is a group, acquire the member list of the group, and get the user identifications of the group members. At this point, establish a connection between clients based on the acquired user identifications, and a communication channel between users involved in the session can be obtained.

In addition, in another embodiment of the present disclosure, because the connection between clients has been achieved by the session between users, the clients between the users do not have to be connected again before an interaction of the network application, and an interactive instruction can be directly transferred between the clients. Specifically, the client includes an instant online communication tool provided by a network interconnected computer by wired communication network and a wireless terminal.

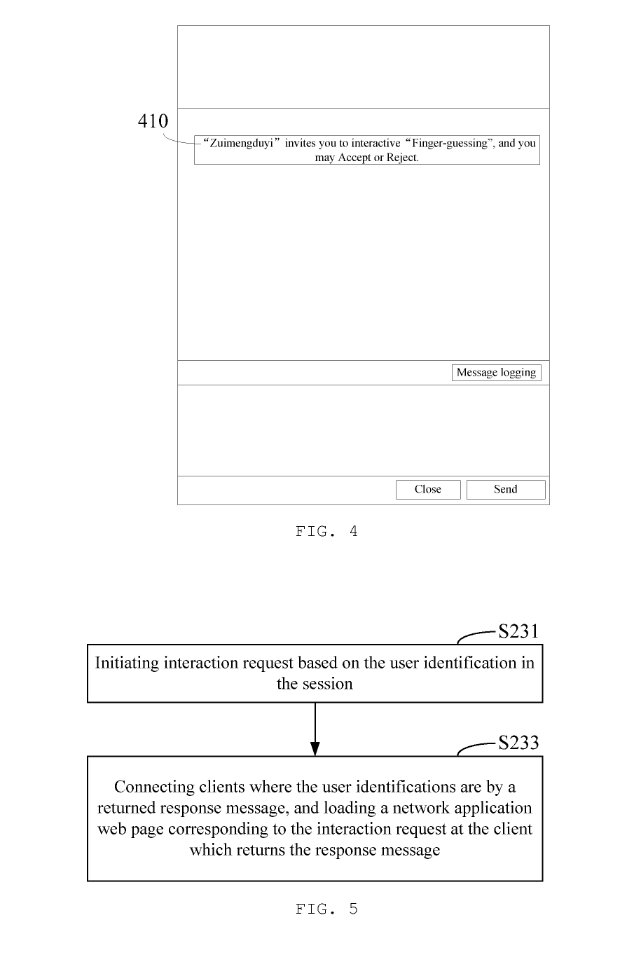

In one embodiment of the present disclosure, as shown in FIG. 5, the step of establishing a connection between clients where the user identifications specifically includes the following steps.

Step S231, initiating interaction request based on the user identification in the session.

In the embodiment, the user who invites other users in the session for an interaction of a network application will initiate an interaction request to other users in the session.

Step S233, connecting clients where the user identifications are by a returned response message, and loading a network application web page corresponding to the interaction request at the client which returns the response message.

In the embodiment, the client at the far end sends a response message based on an operation which means the user accepts the interaction request after receiving the interaction request, to connect the client that initiates the interaction request, the client at the far end loads a network application web page based on the accepted interaction request, to show the network application web page corresponding to the accepted interaction request in the session window provided by the client at the far end, and it makes the client at the far end and the client initiating the interaction request both show the same network application web page.

Step S30, transferring the interactive instruction to a connected client in the session by a client interface of the session window.

In the embodiment, the client is a client that generates a session window. Any operation initiated by a user in the session window can generate a corresponding interactive instruction which is transferred to other connected clients. For example, if the network application is a board game and a connection has been established in the session between clients where user A and user B are, when user A triggers a move operation in the board game web page, a corresponding interactive instruction will be generated and transferred into the client where user B is, to inform the client where user B is that user A has triggered a move operation.

The interaction between the client as a sending end and the client as a receiving end can be implemented by the interactive instruction transmission in the client interface of the session window without a retransmission of the interactive instruction with the action of a backend service, greatly reducing burden of the backend service.

In one embodiment of the present disclosure, as shown in FIG. 6, the above Step S30 specifically includes the following steps.

S310, acquiring the interactive instruction triggered by the network application web page.

S330, calling the client interface where the session window is by the acquired interactive instruction.

In the embodiment, the transfer of the interactive instruction can be implemented by calling the client interface after the network application web page embedded in the session window of the client triggering the interactive instruction. Specifically, a script file in the network application web page can call the client interface to respond the operation in the web page, for example, the scripting language of the network application web page is Javascript, and when an interactive instruction generated in the session window is acquired, Javascript is triggered to make an external object in Javascript call a client interface which is an IIEHost interface, to respond the calling of the network application web page.

Step S350, transferring the interactive instruction to a connected client in the session by a client interface where the session window is located.

In the embodiment, there is a communication channel between clients in the session based on TCP (Transmission Control Protocol) or UDP (User Datagram Protocol). By use of the client interface, the interactive instruction is transferred from the network application web page generating the interactive instruction to a client at the far end by the above communication channel, so as to feedback the operation in the network application web page to the client at the far end.

The transfer of the interactive instruction does not need to search the friend relationship information in the backend service, users interacting with each other can be known by a user in the session in the session window, and according to the corresponding user identifications, the interactive instruction can be transferred, so as to effectively protect the friend relationship information between the users and users' friends and improve the security.

Step S50, updating the web application page in the client following the interactive instruction, to get an updated network application web page.

In the embodiment, the client at the far end can learn the dynamic information of the current network application web page after receiving an interactive instruction, and update the network application web page in the session window, to wait a user corresponding to the client at the far end to trigger a new operation in the updated network application web page.

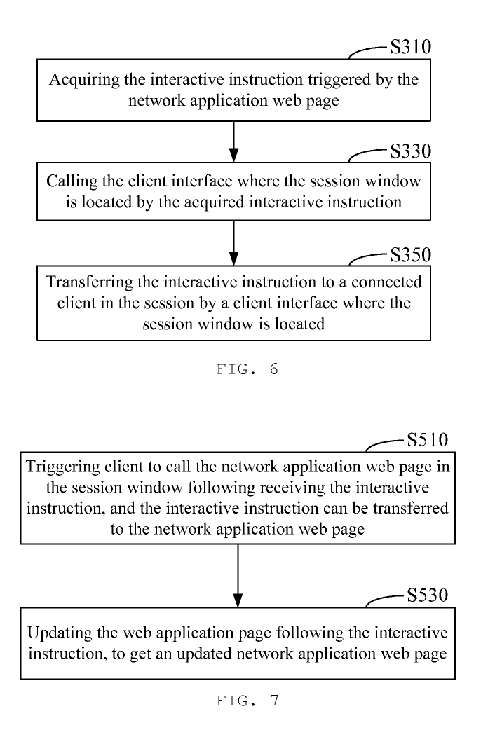

In one embodiment of the present disclosure, as shown in FIG. 7, the above Step S50 specifically includes the following steps.

Step S510, triggering client to call the network application web page in the session window following receiving the interactive instruction, and the interactive instruction can be transferred to the network application web page.

In the embodiment, the client receiving the interactive instruction can call the network application web page embedded in the session window to transfer the interactive instruction.

Step S530, updating the web application page following the interactive instruction, to get an updated network application web page.

In the embodiment, the dynamic information corresponding to the network application web page triggering an operation can be acquired from the interactive instruction, and the network application web page can be updated.

In one embodiment of the present disclosure, as shown in FIG. 8, a client interaction device for network application includes an interaction acquisition module 10, a processing module 30 and an update module 50.

The interaction acquisition module 10 is configured to acquire interactive instruction of the network application in the session window.

In the embodiment, the session window is a window used when a user send a message to other users to talk by an instant online communication tool. A web page of an open platform is embedded in the session window, which integrates a plurality of network applications and category navigations configured to quickly find needed network applications, and users can navigate to relevant network application pages by the category navigation on the web page. For example, when a user clicks a network application, the web page embedded in the session window will load a page corresponded by the clicked network application, to show the user an application scenario of the network application.

The user can interact with other users based on the network application by initiating an operation, such as application interaction, in the network application web page embedded in the session window. Meanwhile, an operation committed by a user in the network application web page can be transferred to a network application web page of another user at the far end by the interactive instruction which can be an instruction generated based on the operation, and the user at the far end can learn the operation happening in the interaction by the interactive instruction, and then reacts to it.

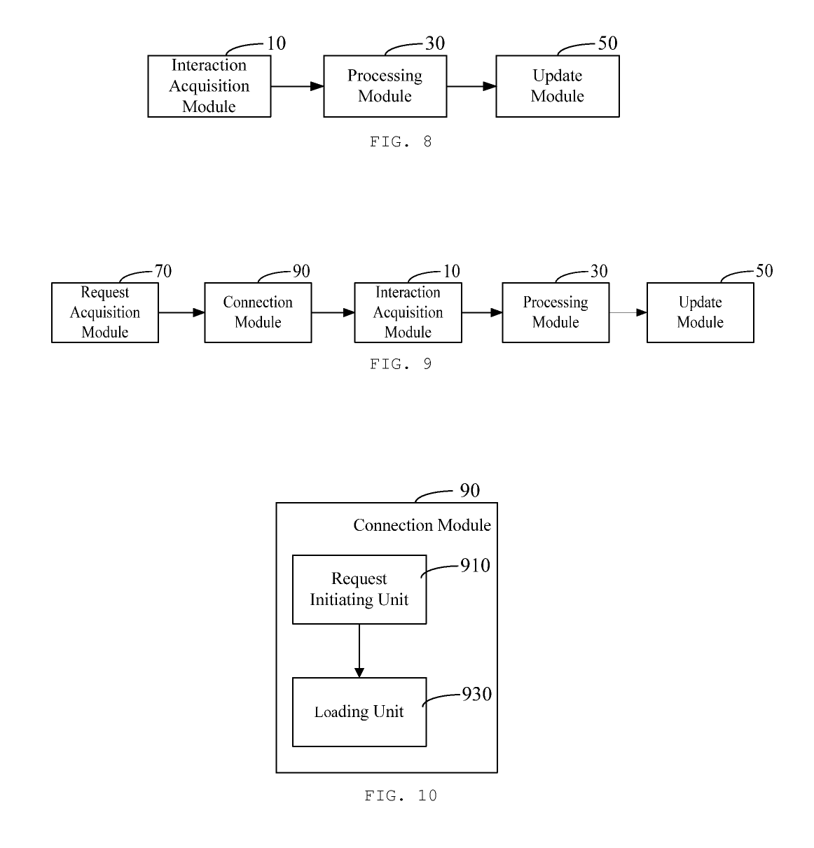

In another embodiment of the present disclosure, as shown in FIG. 9, the above client interaction device for network application also includes a request acquisition module 70 and a connection module 90.

The request acquisition module 70 is configured to acquire an interaction request of the network application in the session window.

In the embodiment, before the interaction in the network application, it firstly needs to establish a communication channel between clients which is implemented by an interaction request initiated by the request acquisition module 70. The client can be an instant online communication tool, and a session window is generated by clicking a contact or friend in the client by a user. The interaction request is an interaction invitation message initiated by a user, the interaction request is shown in the session window, and the user who accepts the interaction request can accept it or reject it.

The connection module 90 is configured to acquire user identifications in the session based on the interaction request, and establish a connection between clients where the user identifications are located.

In the embodiment, when a user logs into the client, the user identification is used to tag the user's identity. After logging into the client, the user identification in the session involves two users or more users in a group. For example, if a session is in a session window provided by the clients of two users, the request connection module 90 acquires user identifications corresponding to the two users; and if a session is a group, the request connection module 90 acquires the member list of the group, and gets the user identifications of the group members. At this point, the request connection module 90 establishes a connection between clients based on the acquired user identifications, and a communication channel between users involved in the session can be obtained.

In addition, in another embodiment of the present disclosure, because the connection between clients has been achieved by the session between users, the clients between the users do not have to be connected again before an interaction of the network application, and an interactive instruction can be directly transferred between the clients. Specifically, the client includes an instant online communication tool provided by a network interconnected computer by wired communication network and a wireless terminal.

In one embodiment of the present disclosure, as shown in FIG. 10, the above connection module 90 includes a request initiating unit 910 and a loading unit 930.

The request initiating unit 910 is configured to initiate an interaction request based on the user identification in the session.

In the embodiment, the user who invites other users in the session for an interaction of a network application will initiate an interaction request to other users in the session by the request initiating unit 910.

The loading unit 930 is configured to connect clients where the user identifications are by a returned response message, and load a network application web page corresponding to the interaction request at the client which returns the response message.

In the embodiment, the client at the far end is used to receive the interaction request, and send a response message based on an operation which means the user accepts the interaction request, to connect the client that initiates the interaction request. The loading unit 930 loads a network application web page based on the accepted interaction request, to show the network application web page corresponding to the accepted interaction request in the session window provided by the client at the far end, and it makes the client at the far end and the client initiating the interaction request both show the same network application web page.

The processing module 30 is configured to transfer the interactive instruction to a connected client in the session by a client interface of the session window.

In the embodiment, the client is a client that generates a session window. Any operation initiated by a user in the session window can generate a corresponding interactive instruction which is transferred to other connected clients by the processing module 30. For example, if the network application is a board game and a connection has been established in the session between clients where user A and user B are, when user A triggers a move operation in the board game web page, a corresponding interactive instruction will be generated and transferred into the client where user B is by the processing module 30, to inform the client where user B is that user A has triggered a move operation.

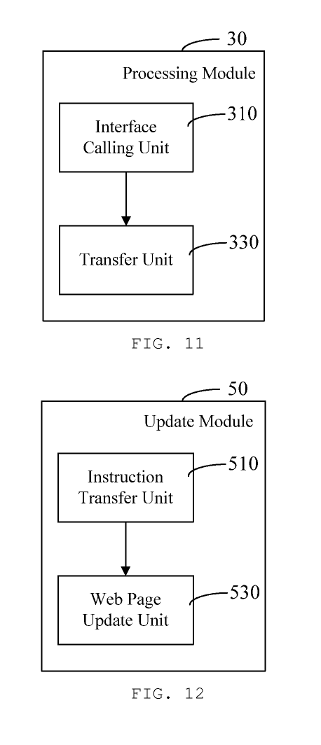

In one embodiment of the present disclosure, as shown in FIG. 11, the above processing module 30 includes an interface calling unit 310 and a transfer unit 330.

The interface calling unit 310 is configured to acquire the interactive instruction triggered by the network application web page, and call the client interface where the session window is by the acquired interactive instruction.

In the embodiment, the interface calling unit 310 can implement the transfer of the interactive instruction by calling the client interface after the network application web page embedded in the session window of the client triggering the interactive instruction. Specifically, the interface calling unit 310 can make a script file in the network application web page call the client interface to respond the operation in the web page, for example, the scripting language of the network application web page is Javascript, and when an interactive instruction generated in the session window is acquired, the interface calling unit 310 is also configured to trigger an external object in Javascript to call a client interface which is an IIEHost interface, to respond the calling of the network application web page.

The transfer unit 330 is configured to transfer the interactive instruction to a connected client in the session by a client interface where the session window is located.

In the embodiment, there is a communication channel between clients in the session based on TCP or UDP. By use of the client interface, the transfer unit 330 transfers the interactive instruction from the network application web page generating the interactive instruction to a client at the far end by the above communication channel, so as to feed back the operation in the network application web page to the client at the far end.

The transfer of the interactive instruction does not need to search the friend relationship information in the backend service, users interacting with each other can be known by a user in the session in the session window, and according to the corresponding user identifications, the interactive instruction can be transferred, so as to effectively protect the friend relationship information between the users and users' friends and improve the security.

The update module 50 is configured to update the web application page in the client following the interactive instruction, to get an updated network application web page.

In the embodiment, in the client at the far end, the update module 50 can learn the dynamic information of the current network application web page after receiving an interactive instruction, and update the network application web page in the session window, to wait a user corresponding to the client at the far end to trigger a new operation in the updated network application web page.

In one embodiment of the present disclosure, as shown in FIG. 12, the above update module 50 includes an instruction transfer unit 510 and a web page update unit 530.

The instruction transfer unit 510 is configured to trigger client to call the network application web page in the session window following receiving the interactive instruction, and transfers the interactive instruction to the network application web page.

In the embodiment, in the client receiving the interactive instruction, the instruction transfer unit 510 can call the network application web page embedded in the session window to transfer the interactive instruction.

The web page update unit 530 is configured to update the web application page following the interactive instruction to get an updated network application web page.

In the embodiment, the web page update unit 530 can acquire the dynamic information corresponding to the network application web page triggering an operation from the interactive instruction, and update the network application web page.

The above client interaction device for network application is provided in the client, wherein the client can be an instant online communication tool.

The above method and device for client interaction of a network application executed by computer firstly acquire interactive instruction of the network application in the session window, then the interaction between users in the network application is achieved by transferring the interactive instruction to a connected client in the session by a client interface of the session window and does not depend on the friend relationship information between the users and users' friends, so as to effectively protect the friend relationship information between the users and users' friends and improve the security.

The present disclosure also provides a computer-readable storage medium for storing computer executable instruction, the computer executable instruction is used to control a computer to execute the above method for client interaction of a network application executed by computer, and the specific steps of implementing client interaction of a network application executed by the computer executable instruction in the computer-readable storage medium are the same as the above method, which are not specifically repeated.

The embodiments are chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for client interaction of a network application executed by computer, comprising:
acquiring an interactive instruction of the network application in the session window;
transferring the interactive instruction to a connected client in the session by a client interface of the session window; and
updating the web application page in the client following the interactive instruction, to get an updated network application web page;
wherein the client is a client that generates the session window.

2. The method of claim 1, wherein before acquiring an interactive instruction of the network application in the session window, it further comprises:
acquiring an interaction request of the network application in the session window;
acquiring user identifications in the session based on the interaction request; and
establishing a connection between clients where the user identifications are located.

3. The method of claim 2, wherein establishing a connection between clients where the user identifications are located comprises:
initiating an interaction request based on the user identification in the session;
receiving the interaction request and sending a response message, by the client at the far end, based on an operation of the user accepting the interaction request; and
connecting clients where the user identifications are by a returned response message, and loading a network application web page corresponding to the interaction request at the client which returns the response message.

4. The method of claim 1, wherein transferring the interactive instruction to a connected client in the session by a client interface of the session window comprises:
acquiring the interactive instruction triggered by the network application web page;
calling the client interface where the session window is by the acquired interactive instruction; and
transferring the interactive instruction to a connected client in the session by a client interface where the session window is located.

5. The method of claim 4, wherein the scripting language of the network application web page is Javascript, Javascript is triggered to make an external object in Javascript call a client interface, and the client interface is an IIEHost interface.

6. The method of claim 1, wherein updating the web application page in the client following the interactive instruction to get an updated network application web page comprises:
triggering client to call the network application web page in the session window following receiving the interactive instruction, and the interactive instruction can be transferred to the network application web page; and
updating the web application page following the interactive instruction, to get an updated network application web page.

7. A client interaction device for network application, comprising:
an interaction acquisition module, configured to acquire interactive instruction of the network application in the session window;
a processing module, configured to transfer the interactive instruction to a connected client in the session by a client interface of the session window; and
an update module, configured to update the web application page in the client following the interactive instruction, to get an updated network application web page;
wherein the client is a client that generates the session window.

8. The client interaction device of claim 7, further comprising:
a request acquisition module, configured to acquire an interaction request of the network application in the session window; and
a connection module, configured to acquire user identifications in the session based on the interaction request, and establish a connection between clients where the user identifications are.

9. The client interaction device of claim 8, wherein the connection module comprises a request initiating unit and a loading unit;
the request initiating unit is configured to initiate interaction request based on the user identification in the session;
the client at the far end is configured to receive the interaction request and send a response message based on an operation of the user accepting the interaction request; and
the loading unit is configured to connect clients where the user identifications are located by a returned response message, and load a network application web page corresponding to the interaction request at the client which returns the response message.

10. The client interaction device of claim 7, wherein the processing module comprises:
an interface calling unit, configured to acquire the interactive instruction triggered by the network application web page and call the client interface where the session window is located by the acquired interactive instruction; and
a transfer unit, configured to transfer the interactive instruction to a connected client in the session by a client interface where the session window is located.

11. The client interaction device of claim 10, wherein the scripting language of the network application web page is Javascript, and when an interactive instruction generated in the session window is acquired, the interface calling unit is further configured to trigger an external object in Javascript to call a client interface which is an IIEHost interface.

12. The client interaction device of claim 7, wherein the update module comprises:
an instruction transfer unit, configured to trigger client to call the network application web page in the session window following receiving the interactive instruction, and transfers the interactive instruction to the network application web page; and
a web page update unit, configured to update the web application page following the interactive instruction to get an updated network application web page.

13. A non-transitory computer-readable storage medium storing computer executable instructions to perform a method for client interaction of a network application, the method comprising:
acquiring an interactive instruction of the network application in the session window;
transferring the interactive instruction to a connected client in the session by a client interface of the session window; and
updating the web application page in the client following the interactive instruction, to get an updated network application web page;
wherein the client is a client that generates the session window.

14. The non-transitory computer-readable storage medium of claim 13, wherein before acquiring an interactive instruction of the network application in the session window, it further comprises:
acquiring an interaction request of the network application in the session window;
acquiring user identifications in the session based on the interaction request; and
establishing a connection between clients where the user identifications are located.

15. The non-transitory computer-readable storage medium of claim 13, wherein establishing a connection between clients where the user identifications are located comprises:
initiating interaction request based on the user identification in the session;
receiving the interaction request and sending a response message, by the client at the far end, based on an operation of the user accepting the interaction request; and
connecting clients where the user identifications are by a returned response message, and loading a network application web page corresponding to the interaction request at the client which returns the response message.

16. The non-transitory computer-readable storage medium of claim 13, wherein transferring the interactive instruction to a connected client in the session by a client interface of the session window comprises:
acquiring the interactive instruction triggered by the network application web page;
calling the client interface where the session window is by the acquired interactive instruction; and
transferring the interactive instruction to a connected client in the session by a client interface where the session window is.

17. The non-transitory computer-readable storage medium of claim 16, wherein the scripting language of the network application web page is Javascript, Javascript is triggered to make an external object in Javascript call a client interface, and the client interface is an IIEHost interface.

18. The non-transitory computer-readable storage medium of claim 13, wherein updating the web application page in the client following the interactive instruction to get an updated network application web page comprises:
triggering client to call the network application web page in the session window following receiving the interactive instruction, and the interactive instruction can be transferred to the network application web page; and
updating the web application page following the interactive instruction, to get an updated network application web page.
